(19) United States
(12) Patent Application Publication
(10) Pub. No.: US 2026/0341080 A1
(43) Pub. Date: Oct. 29, 2026

(54) REMOTE DIAGNOSTIC METHOD AND SYSTEM

(71) Applicant: Autel Intelligent Technology Corp., Ltd., Shenzhen (CN)

(72) Inventor: Zhipeng DU, Shenzhen (CN)

(73) Assignee: Autel Intelligent Technology Corp., Ltd., Shenzhen (CN)

(21) Appl. No.: 19/690,708

(22) Filed: May 28, 2026

Related U.S. Application Data
(63) Continuation of application No. PCT/CN2024/134068, filed on Nov. 25, 2024.

(30) Foreign Application Priority Data
Nov. 28, 2023 (CN) 202311613270.5

(51) Int. Cl. G07C 5/00; H04L 67/12

(52) U.S. Cl. CPC G07C 5/008; H04L 67/12

(57) ABSTRACT

Embodiments of the present disclosure disclose a remote diagnostic method and a system. In the method, when a second communication device receives first communication information sent by a diagnostic device, first response information is sent to the diagnostic device based on the information type of the first communication information. The second communication device then transfers the first communication information to the vehicle through a server and a first communication device. Additionally, the second communication device receives a first reply information from the first communication device via the server and sends first reply information to the diagnostic device, so as to enable the diagnostic device to perform diagnostics on the vehicle based on the first reply information, thereby implementing remote diagnostic functionality.

### CROSS-REFERENCE TO RELATED APPLICATIONS

This application is a continuation of International Application No. PCT/CN2024/134068, filed on Nov. 25, 2024, which claims priority to Chinese Patent Application No. 202311613270.5, filed on Nov. 28, 2023. The entire disclosures of each of the aforementioned applications are incorporated herein by reference in their entirety and for all purposes.

### TECHNICAL FIELD

Embodiments of the present disclosure relate to the technical field of vehicle diagnostics, and in particular, to a remote diagnostic method and a system.

### BACKGROUND

With the development of communication technologies, vehicle diagnostics is no longer limited to local diagnostics, and remote diagnostics can also be adopted. Professionals perform diagnostics on a vehicle through a diagnostic device on the basis of reply information returned by the vehicle. Remote diagnostics is not restricted by regions, thereby solving the problem that the diagnostic device or professionals are located in different places from the vehicle.

However, remote diagnostics has relatively high requirements for real-time performance of communication. If a relatively long network delay occurs during a communication process, data will not be transmitted in a timely manner, and communication will be severed due to reply timeout or data not being transmitted in a timely manner, thereby resulting in relatively low reliability of data transmission and the phenomenon of diagnostic failure.

### SUMMARY

The present disclosure provides a remote diagnostic method and a system, which can solve the problems of data not being transmitted in a timely manner and network diagnostic failure caused by network delay, and improve the reliability of remote diagnostic data transmission.

In a first aspect, some embodiments of the present disclosure provide a remote diagnostic method, performed by a second communication device, including: receiving first communication information sent by a diagnostic device, where the second communication device is included in a remote diagnostic system, and the remote diagnostic system further includes a first communication device and the diagnostic device, where the second communication device is communicatively connected to the diagnostic device and a server respectively, and the first communication device is communicatively connected to the server and a vehicle respectively; sending first response information to the diagnostic device based on an information type of the first communication information, where the first response information is configured for responding to the first communication information; transferring the first communication information to the vehicle through the server and the first communication device, such that the vehicle generates first reply information on the basis of the first communication information; and receiving the first reply information, and sending the first reply information to the diagnostic device, such that the diagnostic device performs remote diagnostics based on the first reply information.

The method can promptly respond to the diagnostic device, thereby implementing near terminal supplementation, and reducing the occurrence of communication being severed or first reply data not being transmitted in a timely manner due to network delay, ultimately causing diagnostic failure, so that delay tolerance is increased, and remote diagnostic data transmission reliability is improved.

In a second aspect, some embodiments of the present disclosure provide a remote diagnostic method, performed by a first communication device, including: receiving first communication information sent by a vehicle, where the first communication device is included in a remote diagnostic system, and the remote diagnostic system further includes a second communication device and a diagnostic device, where the second communication device is communicatively connected to the diagnostic device and a server respectively, and the first communication device is communicatively connected to the server and the vehicle respectively; sending first response information to the vehicle based on an information type of the first communication information, where the first response information is configured for responding to the first communication information; transferring the first communication information to the diagnostic device through the server and the second communication device, such that the diagnostic device generates first diagnostic information based on the first communication information, and the second communication device sends the first diagnostic information to the first communication device via the server; and receiving the first diagnostic information, and sending the first diagnostic information to the vehicle.

In a third aspect, some embodiments of the present disclosure provide a first communication device, where the first communication device is included a remote diagnostic system, and the remote diagnostic system further includes a second communication device and a diagnostic device, where the second communication device is communicatively connected to the diagnostic device and a server respectively, and the first communication device is communicatively connected to the server and a vehicle respectively; the first communication device includes: one or more processors; and a memory communicatively connected to the one or more processors; where the memory stores instructions executable by the one or more processors, and the instructions are executed by the one or more processors to enable the one or more processors to execute the method as described above.

### BRIEF DESCRIPTION OF DRAWINGS

One or more embodiments are exemplarily described with reference to the figures in the corresponding accompanying drawings, and these exemplary descriptions do not constitute limitations on the embodiments. Elements with the same reference numerals in the accompanying drawings are represented as similar elements. Unless otherwise stated, the figures in the accompanying drawings do not constitute scale restrictions.

FIG. 1A is a schematic structural diagram of a remote diagnostic system according to some embodiments of the present disclosure;

FIG. 1B is a schematic structural diagram of a remote diagnostic system according to some embodiments of the present disclosure;

FIG. 2 is a schematic flow diagram of a remote diagnostic method according to some embodiments of the present disclosure;

FIG. 3 is a schematic interaction diagram of various devices in one remote diagnostic system according to some embodiments of the present disclosure;

FIG. 4 is a schematic flow diagram of step S22 as shown in FIG. 2;

FIG. 5 is a schematic flow diagram of a remote diagnostic method according to some embodiments of the present disclosure;

FIG. 6 is a schematic flow diagram of a remote diagnostic method according to some embodiments of the present disclosure; and

FIG. 7 is a schematic structural diagram of a second communication device according to some embodiments of the present disclosure.

### DETAILED DESCRIPTION

The present disclosure will be described in detail below in conjunction with specific embodiments. The following embodiments will help those skilled in the art further understand the present disclosure, but do not limit the present disclosure in any form. It should be noted that for those ordinarily skilled in the art, several variations and improvements may also be made without departing from the concept of the present disclosure, and these all fall within the protection scope of the present disclosure.

In order to make the objectives, technical solutions and advantages of the present disclosure clearer, the present disclosure will be described in further detail below in conjunction with the accompanying drawings and embodiments. It should be understood that the specific embodiments described herein are only used for explaining the present disclosure and are not used for limiting the present disclosure.

It should be noted that if there is no conflict, various features in the embodiments of the present disclosure may be combined with each other, which all fall within the protection scope of the present disclosure. In addition, although functional modules are divided in the apparatus schematic diagrams and logical sequences are shown in the flowcharts, under certain conditions, the steps shown or described may be executed in sequences different from those in the module division in the apparatus or the flowcharts. In addition, words such as “first”, “second” and “third” adopted herein do not limit data and execution sequences, but only distinguish identical or similar items with basically the same functions and effects.

Unless otherwise defined, all technical and scientific terms used in this specification have the same meanings as commonly understood by those skilled in the technical field to which the present disclosure belongs. In this specification, terms used in the specification of the present disclosure are only for the purpose of describing specific implementation modes and are not used for limiting the present disclosure. The term “and/or” used in this specification includes any and all combinations of one or more related listed items.

In addition, technical features involved in various implementation modes of the present disclosure described below may be combined with each other as long as they do not conflict with each other.

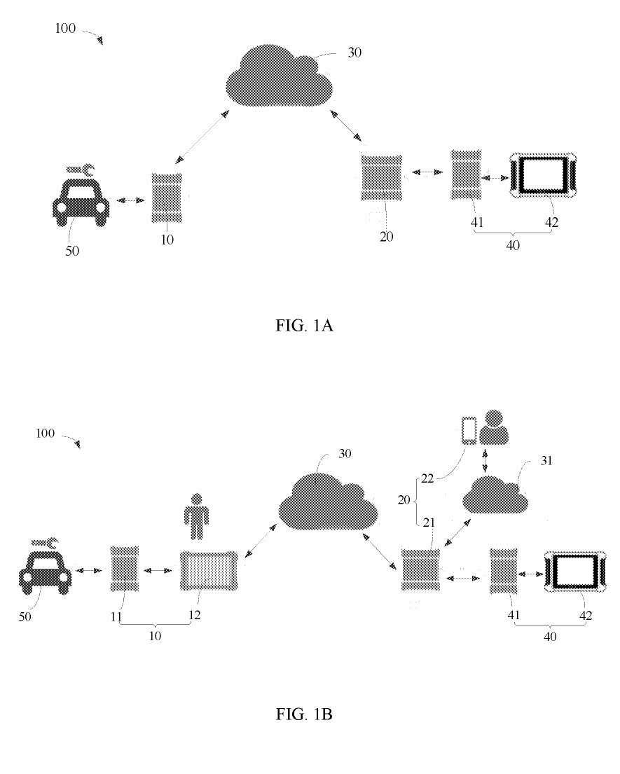

FIG. 1A is a schematic structural diagram of a remote diagnostic system 100 according to some embodiments of the present disclosure. The remote diagnostic system 100 includes a first communication device 10, a second communication device 20 and a server 30, the first communication device 10 is communicatively connected to a vehicle 50 and the server 30, and the second communication device 20 is communicatively connected to the server 30 and a diagnostic device 40.

Where the first communication device 10 is a vehicle communication interface (VCI) which is an electronic device having computing and processing capabilities and integrated with a communication interface, such as an on-board diagnostics (OBD) interface. The first communication device 10 may be communicatively connected to an OBD interface of the vehicle 50 through the OBD interface, and the first communication device 10 can convert data on a vehicle bus into data recognizable by the server 30, and can also convert data issued by the server 30 into data recognizable by the vehicle bus. In addition, the first communication device 10 also has a wireless communication function, can be communicatively connected to the server 30 through a network such as WIFI, and can also be communicatively connected to the server 30 in a wired connection mode, thereby enabling communication to be more reliable. In some embodiments, the first communication device 10 further includes a touch display screen, so as to receive operation of an operator or display operation instructions, diagnostic conditions or related data, and the like.

Referring to FIG. 1B, in some embodiments, the first communication device 10 includes a first communication apparatus 11 and a first mobile terminal 12 which are independent of each other. Herein, the first communication apparatus 11 may be a VCI, and the first mobile terminal 12 may be a tablet computer, a smart phone or handheld smart devices in various forms, and the like. In the present embodiment, the first communication apparatus 11 is wiredly connected to the OBD interface of the vehicle 50 and also wiredly connected to the first mobile terminal 12, for example, may be wiredly connected to the first mobile terminal 12 by adopting a universal serial bus (USB). The first mobile terminal 12 is communicatively connected to the server 30 through a network such as WIFI, and the first mobile terminal 12 can also be communicatively connected to the server 30 in a wired connection mode, thereby enabling communication to be more reliable. It can be understood that the first mobile terminal 12 includes a touch display screen, so as to receive operation of an operator or display operation instructions, diagnostic conditions or related data, and the like.

The second communication device 20 is a VCI which is an electronic device having computing and processing capabilities and integrated with a communication interface, such as an OBD interface. The second communication device 20 may be communicatively connected to an OBD interface of the diagnostic device 40 through the OBD interface, and the second communication device 20 can convert data on a diagnostic device bus into data recognizable by the server 30, and can also convert data issued by the server 30 into data recognizable by the diagnostic device 40 bus. In addition, the second communication device 20 may have a wireless communication function, can be communicatively connected to the server 30 through a network such as WIFI, and may also be communicatively connected to the server 30 in a wired connection mode, thereby enabling communication to be more reliable. In some embodiments, the second communication device 20 further includes a touch display screen, so as to receive operation of an operator or display operation instructions, diagnostic conditions or related data, and the like.

Referring to FIG. 1B again, in some embodiments, the second communication device 20 includes a second communication apparatus 21 and a second mobile terminal 22 which are independent of each other. Herein, the second communication apparatus 21 can be a VCI, and the second mobile terminal 22 can be a tablet computer, a smart phone or handheld smart devices in various forms, and the like, where the second communication apparatus 21 is communicatively connected to the second mobile terminal 22 through an Internet of Things (IoT) server 31, and the IoT server 31 is specially responsible for transmitting commands for synchronizing human-machine interaction states.

In the present embodiment, the second communication apparatus 21 is wiredly connected to the OBD interface of the diagnostic device 40 and also connected to the second mobile terminal 22 through a server network. The second mobile terminal 22 is communicatively connected to the server 30 through a network, such as a network cable or WIFI. It can be understood that the second mobile terminal 22 includes a touch display screen, so as to receive operation of an operator or display operation instructions, diagnostic conditions or related data, and the like.

That is, the first communication device 10 and the second communication device 20 may be the same communication device with the same hardware and software. The only difference is that the first communication device 10 is applied to a vehicle-proximal end and communicatively connected to the OBD interface of the vehicle 50 and the server 30, and the second communication device 20 is applied to a vehicle-remote end and used for being communicatively connected to the diagnostic device 40 and the server 30. It can be understood by those skilled in the art that “first” and “second” herein do not constitute any limitation on the communication devices.

The server 30 can be a local physical server or a cloud device, such as a cloud server, a cloud host, a cloud service platform, and a cloud computing platform. The cloud device is communicatively connected to the first communication device 10 or the second communication device 20 through a network, and the two are communicatively connected through a predetermined communication protocol. Specifically, the communication protocol may be protocols such as a Transmission Control Protocol/Internet Protocol (TCP/IP). In other embodiments, the first communication device 10 may be communicatively connected to the second communication device 20 by adopting a Peer-to-Peer (P2P) protocol, so that the first communication device 10 may be communicatively connected to the second communication device 20 without the server 30, that is, the server 30 may not be included in the remote diagnostic system 100.

The diagnostic device 40 is a portable intelligent vehicle fault self-check instrument for detecting vehicle faults. A user can utilize the diagnostic device for rapidly reading faults in an electronic control system of a vehicle, fault information is displayed through a liquid crystal display screen, and the location and cause of the fault can be rapidly found out. It can be understood that an existing vehicle diagnostic instrument on the market can be adopted as the diagnostic device 40, which includes an upper computer 42 and a lower computer 41, and the two can be connected in a wired or wireless connection mode, for example, connected through a USB, Bluetooth, and WIFI. The upper computer 42 can be a device such as a tablet and a computer for human-machine interaction, and the lower computer 41 can be a VCI for being communicatively connected to the upper computer 42 and the second communication apparatus 21. The structure and working principle of the diagnostic device 40 are well known to those skilled in the art, and will not be described in detail herein.

In some embodiments, both the first communication device 10 (for example, the first mobile terminal therein) and the second communication device 20 (for example, the second mobile terminal therein) are loaded with application software. It can be understood that the application software serves as a platform for remote communication, and a requester at the vehicle-proximal end may post a help-seeking question on the application software in the first communication device 10 or the first mobile terminal and upload the help-seeking question to the server 30. Related technical experts may acquire the help-seeking question on the application software in the second communication device 20 or the second mobile terminal, so as to help the requester solve the help-seeking question.

In the above mode, a communication network from the vehicle to the first communication device 10, the server 30, the second communication device 20 and the diagnostic device 40 is formed. In the communication network, any two entities may communicate with each other, so that the diagnostic device 40 is not limited by a geographic position, that is, it is not necessary to confine the diagnostic device 40 to the vicinity of the vehicle, thereby achieving remote diagnostics and providing a wider range of fault solution channels for the vehicle. For example, when maintenance personnel of a vehicle maintenance shop cannot solve the fault, the maintenance personnel may seek help remotely, find more experienced technical experts, and enable the vehicle 50 to be communicatively connected to the diagnostic device 40 through the above communication network to solve the fault. For another example, when the diagnostic device of the vehicle maintenance shop does not match with the model of a faulty vehicle, the faulty vehicle may be communicatively connected to a matched diagnostic device 30 remotely to solve the fault. It can be seen that remote diagnostics can integrate expert resources and diagnostic device resources, thereby improving the maintenance efficiency.

The above is only an illustrative description of the remote diagnostic system 100, and the remote diagnostic system 100 may also be implemented in other hardware plus software modes. For example, the functionality of the second communication device 20 may be implemented by software, a network communication interface may be added to the software of the diagnostic device 40, and data transmission with the server 30 is performed through the network communication interface.

In the above remote diagnostic system, remote diagnostic functionality is implemented through communication between various devices. Specifically, the second communication device receives the first communication information sent by the diagnostic device, and sends the first communication information to the vehicle through the server and the first communication device. The vehicle generates first reply information on the basis of the first communication information, and the vehicle transfers the first reply information to the first communication device. The first communication device receives the first reply information sent by the vehicle, and sends the first reply information to the second communication device through the server. Finally, the second communication device sends the first reply information to the diagnostic device, and the diagnostic device perform diagnostics work on the vehicle on the basis of the first reply information to implement the remote diagnostic functionality.

However, network delay often occurs during the communication process of remote diagnostics, so that data will not be transmitted in a timely manner, or communication will be severed due to network delay, network jamming or network instability, thereby resulting in timeout of the first reply information sent by the vehicle and then causing diagnostic failure.

On the basis of the above reasons, some embodiments of the present disclosure provide a remote diagnostic method, which reduces the problem of diagnostic failure caused by network delay through a near terminal supplementation method, increases delay tolerance, and then improves data transmission stability.

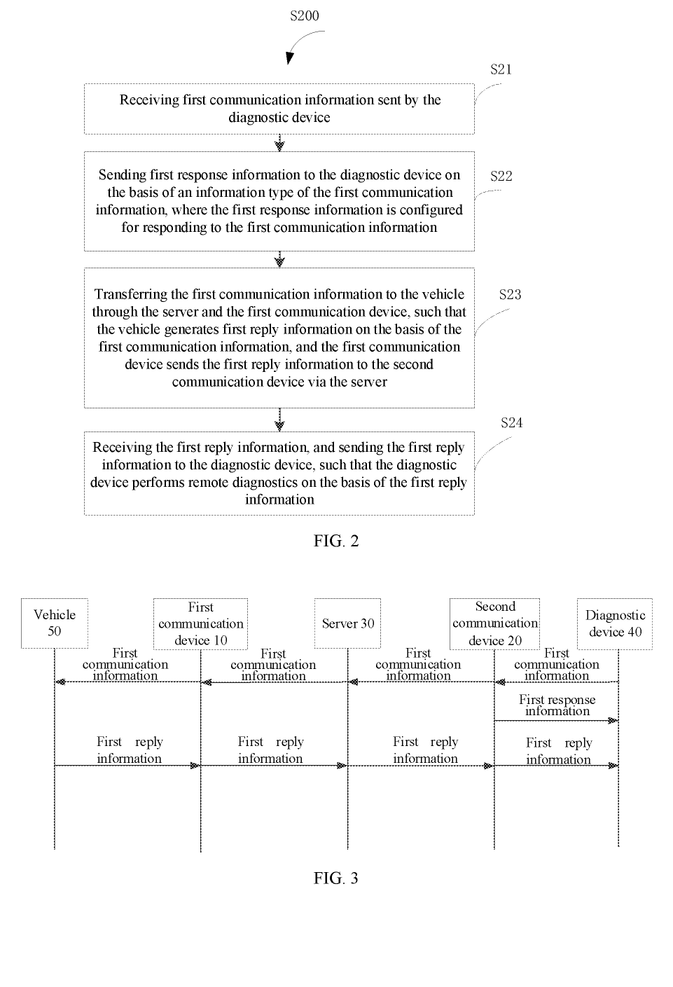

FIG. 2 is a schematic flow diagram of a remote diagnostic method according to some embodiments of the present disclosure. As shown in FIG. 2, the remote diagnostic method S200 is applied to a second communication device, and the method includes:

S21, receiving first communication information sent by a diagnostic device.

Referring to FIG. 3 together, after a communication link is established, normal remote diagnostic functionality is started. The diagnostic device sends the first communication information to the second communication device, and the first communication information is certain communication data or a communication instruction and the like during a diagnostic process, such as a diagnostic request instruction, a connection test instruction or diagnostic data. The first communication information may be a single frame or multiple frames.

S22, sending first response information to the diagnostic device on the basis of an information type of the first communication information, where the first response information is configured for responding to the first communication information.

S23, transferring the first communication information to a vehicle through a server and a first communication device, such that the vehicle generates first reply information on the basis of the first communication information, and the first communication device sends the first reply information to the second communication device via the server.

During a diagnostic process, after receiving the first communication information, the second communication device transfers the first communication information to an electronic control unit (ECU) in the vehicle via the server and the first communication device. The ECU in the vehicle generates first reply information on the basis of the first communication information, and the first communication device transfers the first reply information to the diagnostic device via the server and the second communication device.

However, if network delay or network jamming exists, the occurrence of timeout or communication being severed has been caused when the first reply information is transferred to the diagnostic device, thereby causing diagnostic functionality failure.

Therefore, in the embodiments of the present disclosure, when receiving the first communication information, the second communication device sends first response information to the diagnostic device to respond to the first communication information, so as to achieve rapid response. Through such a near terminal supplementation method, network timeout may be avoided, delay tolerance may be increased, and normal communication functionality may be kept.

S24, receiving the first reply information, and sending the first reply information to the diagnostic device, such that the diagnostic device performs remote diagnostics on the basis of the first reply information.

After subsequently receiving the first reply information, the second communication device sends the first reply information to the diagnostic device, so as to enable the diagnostic device to execute diagnostic functionality on the basis of the first reply information to complete remote diagnostics.

In summary, in the remote diagnostic method, firstly the first communication information sent by diagnostic device is received, and then first response information is sent to the diagnostic device on the basis of an information type of the first communication information, the first response information being used for responding to the first communication information; then the first communication information is transferred to the vehicle through the server and the first communication device, so as to enable the vehicle to generate the first reply information on the basis of the first communication information; and finally the first response information is received and the first response information is sent to the diagnostic device. In the method, when the second communication device receives the first communication information sent by the diagnostic device, the first response information is sent to the diagnostic device on the basis of the information type of the first communication information, so as to promptly respond to the diagnostic device, thereby implementing near terminal supplementation, and reducing the occurrence of communication being severed or first reply data not being transmitted in a timely manner due to network delay, ultimately causing diagnostic failure, so that delay tolerance is increased, and remote diagnostic data transmission reliability is improved. Additionally, the second communication device sends the first reply information to the diagnostic device, so as to enable the diagnostic device to perform diagnostics on the vehicle on the basis of the first reply information, thereby implementing remote diagnostic functionality.

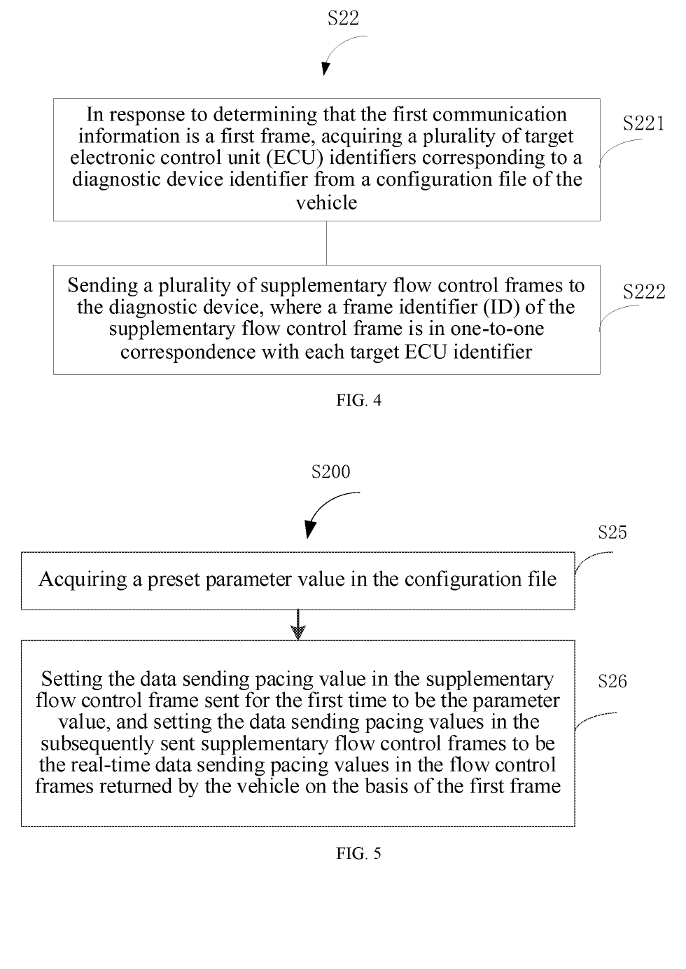

Near terminal supplementation measures in the remote diagnostic method are different for different communication protocols. In an embodiment, in response to determining that a communication protocol of the remote diagnostic system is a unified diagnostic services (UDS) protocol or an ISO15765 protocol, as shown in FIG. 4, step S22 includes:

S221, in response to determining that the first communication information is a first frame, acquiring a plurality of target electronic control unit (ECU) identifiers corresponding to a diagnostic device identifier from a configuration file of the vehicle; and

S222, sending a plurality of supplementary flow control frames to the diagnostic device, where a frame identifier (ID) of the supplementary flow control frame is in one-to-one correspondence with each target ECU identifier.

When the diagnostic device sends multi-frame data to the ECU of the vehicle, it is necessary to firstly send a first frame once. A multi-frame is a data frame greater than 8 bytes, it is necessary to divide the multi-frame data into a plurality of data frames to be sent, and the first frame is used for informing a receiver of the form, data size, and the like of the multi-frame data sent by a sender.

After receiving the first frame, the ECU of a vehicle returns a flow control frame, and the flow control frame contains information such as an acceptable data sending pacing value and an acceptable data size, so as to enable the diagnostic device to send the multi-frame data in accordance with the provisions in the flow control frame.

When the diagnostic device sends the first frame, the frame ID of the first frame is a diagnostic device identifier, that is, a TOOLS ID. The vehicle includes a plurality of ECUs, and each ECU has an identifier thereof, that is, each ECU has an ECU identifier thereof, that is, an ECU ID. However, ECU identifiers corresponding to different vehicle models and vehicle series are also different. When the vehicle replies with a flow control frame on the basis of the first frame, the frame ID of the flow control frame is the corresponding ECU identifier, and one diagnostic device identifier may correspond to a plurality of ECU identifiers.

However, when the second communication device sends the supplementary flow control frame to the diagnostic device, the flow control frame replied by the ECU of the vehicle has not been obtained, and then the frame ID of the flow control frame cannot be acquired. Therefore, when the second communication device sends the supplementary flow control frame to the diagnostic device, the plurality of target electronic control unit (ECU) identifiers corresponding to the diagnostic device identifier are acquired according to the configuration file of the vehicle, where the configuration file of the vehicle may be acquired from the server through a Vehicle Identification Number (VIN), and various data of the vehicle are pre-stored in a database of the server. The server looks up various data corresponding to the VIN from the database according to the VIN, generates a corresponding configuration file on the basis of the found data, and sends the configuration file to the second communication device, where the configuration file reflects the ECU identifier of the vehicle and communication attributes thereof, such as a baud rate, an ECU pin or a protocol identifier.

After acquiring the plurality of target ECU identifiers corresponding to the diagnostic device identifier, the second communication device sends one supplementary flow control frame according to each ECU identifier. The number of the supplementary flow control frames corresponds to the number of the ECU identifiers, and the frame ID of each supplementary flow control frame is in one-to-one correspondence with each target ECU identifier.

When one diagnostic device identifier corresponds to a plurality of ECU identifiers, by the above method, near terminal supplementation may be performed on the diagnostic device to rapidly respond the diagnostic device. Additionally, regardless of the model or series of the actual vehicle, and regardless of which identifier the ECU of the vehicle adopts to respond to the first frame with a flow control frame, compensation with supplementary flow control frames may be provided to prevent compensation failure, thereby avoiding the impact of network delay on multi-frame data sending.

In some embodiments, different vehicle models include different ECUs and correspond to different diagnostic devices. If the second communication device replies with the supplementary flow control frame to the diagnostic device too rapidly, the diagnostic device may fail to receive and discard the supplementary flow control frame, so that the effect of near terminal supplementation cannot be achieved. Therefore, for some vehicle models, after acquiring the plurality of target ECU identifiers corresponding to the diagnostic device identifier from the configuration file of the vehicle, and before sending the plurality of supplementary flow control frames to the diagnostic device, the second communication device also acquires a first time interval between the first frame and the supplementary flow control frame from the configuration file, and sends a plurality of corresponding supplementary flow control frames to the diagnostic device after the first time interval elapses after receiving the first frame.

By the above method, it can be ensured that the diagnostic device can correctly receive the corresponding supplementary flow control frames, thereby preventing near terminal supplementation failure, then avoiding the impact of network timeout on diagnostic functionality, and improving network stability.

In some embodiments, for some vehicle models, a time interval between receiving the supplementary flow control frame and sending the data frame by the diagnostic device is also controlled. Specifically, the second communication device acquires a second time interval from the configuration file, and sends the second time interval to the diagnostic device, so as to enable the diagnostic device to send the data frame after the second time interval elapses after receiving the supplementary flow control frame.

By the above method, the diagnostic device may control the sending time of the data frame after receiving the supplementary flow control frames, so as to ensure correct communication between the diagnostic device and the ECU and prevent data transmission failure.

It should be noted that not all configuration files include the first time interval and the second time interval. Only configuration files of some vehicle models or vehicle types requiring time interval control include the first time interval and the second time interval. For some vehicles not requiring time interval control, sending is performed at the highest speed of code processing without control.

In some embodiments, when the diagnostic device sends one piece of multi-frame data to the second communication device, firstly a first frame is sent, the second communication device sends a supplementary flow control frame to the diagnostic device for the first time, then the diagnostic device sends a plurality of data frames to the second communication device, and the second communication device sends supplementary flow control frames multiple times for the plurality of data frames. Therefore, in one multi-frame data sending cycle, the second communication device sends the supplementary flow control frames to the diagnostic device multiple times, where a data sending pacing value in the supplementary flow control frame sent for the first time is set to be a preset empirical value, and data sending pacing values in the subsequently sent supplementary flow control frames are set to be real-time data sending pacing values in flow control frames returned by the vehicle on the basis of the first frame. The data sending pacing value refers to a frequency of sending the data frames when a plurality of data frames are subsequently sent after the diagnostic device sends the first frame, and one data frame is sent at every one data sending pacing value interval.

By the above method, the data sending pacing values in the supplementary flow control frames may be synchronized with the real-time data sending pacing values returned by the vehicle, so that the supplementary flow control frames are synchronized with the flow control frames returned by the vehicle, thereby improving compensation accuracy and then further improving network stability.

In some embodiments, for some vehicle models, if the data sending pacing value in the supplementary flow control frame sent for the first time is the preset empirical value, the data sending pacing value is invalid data for the diagnostic device, which may cause the corresponding diagnostic device to fail to receive the data sending pacing value. Therefore, for these vehicle models, the data sending pacing value in the supplementary flow control frame sent for the first time is acquired through the configuration files corresponding to these vehicle models. In an embodiment, as shown in FIG. 5, the method S200 further includes:

S25. acquiring a preset parameter value in the configuration file; and

S26. setting the data sending pacing value in the supplementary flow control frame sent for the first time to be the parameter value, and setting the data sending pacing values in the subsequently sent supplementary flow control frames to be the real-time data sending pacing values in the flow control frames returned by the vehicle on the basis of the first frame.

The server may look up and obtain the configuration file from the database according to the VIN of the vehicle. The configuration file is a unique and single configuration file generated for the type, the model, the year of the vehicle, and the like, and includes various specific and unique communication parameters of the vehicle. The configuration file may be obtained by testing the vehicle in advance. For example, the first frame is sent to the ECU of the vehicle, the ECU of the vehicle returns the flow control frame on the basis of the first frame, the flow control frame contains the real-time data sending pacing value corresponding to the vehicle, and the real-time data sending pacing value is placed in the configuration file as the preset parameter value for use in subsequent diagnostics.

The data sending pacing value in the supplementary flow control frame sent for the first time is set to be the preset parameter value to prevent near terminal supplementation failure and avoid the impact of delay, and the data sending pacing values in the subsequently sent supplementary flow control frames are the real-time data sending pacing values in the flow control frames returned by the vehicle on the basis of the first frame, so as to synchronize with the real-time data sending pacing values in the flow control frames returned by the ECU of the vehicle.

In some embodiments, when the communication protocol of the remote diagnostic system is a TP20/TP16 protocol, if an information type of the first communication information is a connection test frame (CT frame), a connection acknowledgment frame (CA frame) is sent to the diagnostic device. In the above mode, the purpose of rapid response and timeout avoidance is achieved.

In some embodiments, when the communication protocol of the remote diagnostic system is the TP20/TP16 protocol, if the information type of the first communication information is a first data frame (DTA frame), a first acknowledgment frame (ACK frame) is sent to the diagnostic device.

After sending the first acknowledgment frame to the diagnostic device, the second communication device transfers the first data frame to the vehicle through the server and the first communication device. The ECU of the vehicle generates a first reply frame (reply DT frame) and a second acknowledgment frame (ACK frame) on the basis of the first data frame. At this time, the first communication device filters out the second acknowledgment frame, and transfers the first reply frame to the second communication device via the server. The second communication device receives the first reply frame and sends the first reply frame to the diagnostic device.

It should be noted that in the various embodiments above, there is not necessarily a fixed sequence between the various steps. Those ordinarily skilled in the art may understand that in different embodiments, the various steps above may have different execution sequences, that is, may be executed in parallel, and may also be executed alternatively, and the like according to the descriptions of the embodiments of the present disclosure.

In summary, in the remote diagnostic method, when the second communication device receives the first communication information sent by the diagnostic device, the first response information is sent to the diagnostic device on the basis of the information type of the first communication information, so as to promptly respond to the diagnostic device, thereby implementing near terminal supplementation, and reducing the occurrence of communication being severed or first reply data not being transmitted in a timely manner due to network delay, ultimately causing diagnostic failure, so that delay tolerance is increased, and remote diagnostic data transmission reliability is improved. Additionally, the second communication device sends the first reply information to the diagnostic device, so as to enable the diagnostic device to perform diagnostics on the vehicle on the basis of the first reply information, thereby implementing remote diagnostic functionality.

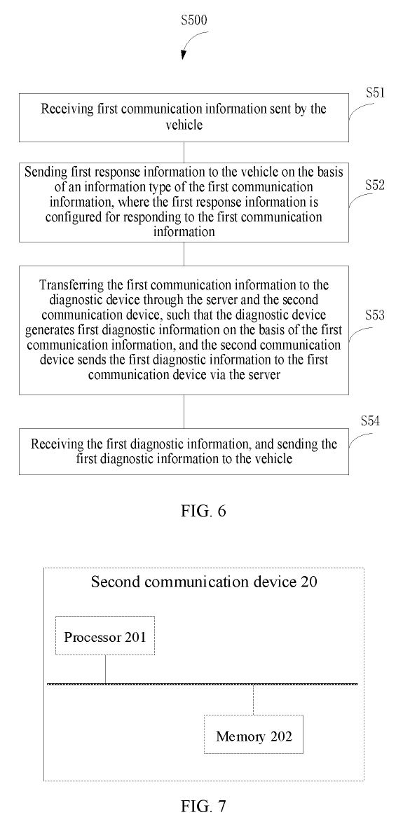

The above remote diagnostic method is also applicable to the first communication device. During the communication process between the first communication device and the vehicle, the first communication device provides near terminal supplementation for the vehicle to avoid the impact of delay. In an embodiment, referring to FIG. 6, which is a schematic flow diagram of a remote diagnostic method according to some embodiments of the present disclosure. The remote diagnostic method is applied to a first communication device. As shown in FIG. 6, the remote diagnostic method S500 includes:

S51, receiving first communication information sent by the vehicle;

S52, sending first response information to the vehicle on the basis of an information type of the first communication information, where the first response information is configured for responding to the first communication information;

S53, transferring the first communication information to the diagnostic device through the server and the second communication device, such that the diagnostic device generates first diagnostic information on the basis of the first communication information, and the second communication device sends the first diagnostic information to the first communication device via the server; and

S54, receiving the first diagnostic information, and sending the first diagnostic information to the vehicle.

In summary, in the remote diagnostic method, when the first communication device receives the first communication information sent by the vehicle, the first response information is sent to the vehicle on the basis of the information type of the first communication information, so as to promptly respond to the vehicle, thereby implementing near terminal supplementation, and reducing the occurrence of communication being severed or first reply data not being transmitted in a timely manner due to network delay, ultimately causing diagnostic failure, so that delay tolerance is increased, and remote diagnostic data transmission reliability is improved. Additionally, the first communication device sends the first diagnostic information to the vehicle, so as to implement remote diagnostic functionality.

In some embodiments, if it is detected that the diagnostic device does not send a request frame (single frame or multi-frame) to the vehicle beyond a first preset duration, a link keep-alive frame is sent to the vehicle, so as to enable the vehicle to keep a communication link.

It should be noted that since the remote diagnostic method S500 applied to the first communication device is on the basis of the same inventive concept as the remote diagnostic method S200 applied to the second communication device in the foregoing embodiment, corresponding content of the foregoing remote diagnostic method S200 is also applicable to the embodiment of the remote diagnostic method S500, which will not be described in detail herein.

It should be noted that in the various embodiments above, there is not necessarily a fixed sequence between the various steps. Those ordinarily skilled in the art may understand that in different embodiments, the various steps above may have different execution sequences, that is, may be executed in parallel, and may also be executed alternatively, and the like according to the descriptions of the embodiments of the present disclosure.

In summary, in the remote diagnostic method, when the first communication device receives the first communication information sent by the vehicle, the first response information is sent to the vehicle on the basis of the information type of the first communication information, so as to promptly respond to the vehicle, thereby implementing near terminal supplementation, and reducing the occurrence of communication being severed or first reply data not being transmitted in a timely manner due to network delay, ultimately causing diagnostic failure, so that delay tolerance is increased, and remote diagnostic data transmission reliability is improved. Additionally, the first communication device sends the first diagnostic information to the vehicle, so as to implement remote diagnostic functionality.

FIG. 7 is a schematic structural diagram of a second communication device according to some embodiments of the present disclosure, where the second communication device is applied to a remote diagnostic system, and the remote diagnostic system further includes a first communication device and a diagnostic device, where the second communication device is communicatively connected to the diagnostic device and a server respectively, and the first communication device is communicatively connected to the server and a vehicle respectively.

As shown in FIG. 7, the second communication device 20 includes at least one processor 201 and a memory 202 (taking connection by a bus and one processor as an example in FIG. 7) which are communicatively connected.

Where the processor 201 is used for providing computing and control capabilities to control the second communication device to execute a corresponding task, for example, control the second communication device to execute the remote diagnostic method in any one of the foregoing method embodiments. The method includes receiving first communication information sent by the diagnostic device, and sending first response information to the diagnostic device on the basis of an information type of the first communication information, the first response information being used for responding to the first communication information; then transferring the first communication information to the vehicle through the server and the first communication device, so as to enable the vehicle to generate first reply information on the basis of the first communication information; and finally receiving the first reply information and sending the first reply information to the diagnostic device, so as to enable the diagnostic device to perform remote diagnostics on the basis of the first reply information.

The method can promptly respond to the diagnostic device, thereby implementing near terminal supplementation, and reducing the occurrence of communication being severed or first reply data not being transmitted in a timely manner due to network delay, ultimately causing diagnostic failure, so that delay tolerance is increased, and remote diagnostic data transmission reliability is improved.

The processor 201 may be a general-purpose processor, including a central processing unit (CPU), a network processor (NP), a hardware chip or any combination thereof; and may also be a digital signal processor (DSP), an application specific integrated circuit (ASIC), a programmable logic device (PLD) or a combination thereof. The above PLD may be a complex programmable logic device (CPLD), a field-programmable gate array (FPGA), a generic array logic (GAL) or any combination thereof.

As a non-transitory computer-readable storage medium, the memory 202 may be used for storing non-transitory software programs, non-transitory computer-executable programs and modules, such as program instructions/modules corresponding to the remote diagnostic method in the embodiments of the present disclosure. The processor 201 may implement the remote diagnostic method in any one of the foregoing method embodiments by running the non-transitory software programs, instructions and modules stored in the memory 202, which will not be described in detail herein to avoid repetition.

In some embodiments, the memory 202 may include a volatile memory (VM), such as a random access memory (RAM); the memory 202 may also include a non-volatile memory (NVM), such as a read-only memory (ROM), a flash memory, a hard disk drive (HDD) or a solid-state drive (SSD) or other non-transitory solid-state storage devices; and the memory 202 may further include a combination of the above types of memories.

In some embodiments of the present disclosure, the memory 202 may further include memories remotely disposed relative to the processor, and these remote memories may be connected to the processor through a network. Examples of the above network include, but are not limited to, the Internet, an intranet, a local area network, a mobile communication network and combinations thereof.

Some embodiments of the present disclosure further provide a first communication device, which has the same structure as the second communication device in FIG. 7, which will not be described in detail herein.

Some embodiments of the present disclosure further provide a computer-readable storage medium, such as a memory including program codes, and the above program codes may be executed by a processor to complete the remote diagnostic method in the foregoing embodiment. For example, the computer-readable storage medium may be a read-only memory (ROM), a random access memory (RAM), a compact disc read-only memory (CDROM), a magnetic tape, a floppy disk, an optical data storage device, and the like.

Some embodiments of the present disclosure further provide a computer program product, including one or more program codes stored in a computer-readable storage medium. A processor of an electronic device reads the program codes from the computer-readable storage medium, and the processor executes the program codes to complete the method steps of the remote diagnostic method provided in the foregoing embodiment.

The remote diagnostic method provided by the embodiments of the present disclosure is applied to a remote diagnostic system, and the remote diagnostic system includes a second communication device, a first communication device and a diagnostic device, where the second communication device is communicatively connected to the diagnostic device and a server respectively, and the first communication device is communicatively connected to the server and a vehicle respectively. Firstly, the second communication device receives first communication information sent by the diagnostic device, and then sends first response information to the diagnostic device on the basis of an information type of the first communication information, the first response information being used for responding to the first communication information; then the second communication device transfers the first communication information to the vehicle through the server and the first communication device, so as to enable the vehicle to generate first reply information on the basis of the first communication information, and the first communication device acquires the first reply information sent by the vehicle and sends the first reply information to the second communication device through the server; and finally, the second communication device sends the first reply information to the diagnostic device, so as to enable the diagnostic device to perform remote diagnostics on the basis of the first reply information. In the method, when the second communication device receives the first communication information sent by the diagnostic device, the first response information is sent to the diagnostic device on the basis of the information type of the first communication information, so as to promptly respond to the diagnostic device, thereby implementing near terminal supplementation, and reducing the occurrence of communication being severed or first reply data not being transmitted in a timely manner due to network delay, ultimately causing diagnostic failure, so that delay tolerance is increased, and remote diagnostic data transmission reliability is improved. Additionally, the second communication device sends the first reply information to the diagnostic device, so as to enable the diagnostic device to perform diagnostics on the vehicle on the basis of the first reply information, thereby implementing remote diagnostic functionality.

The above embodiments are only used for illustrating the technical solutions of the present disclosure, but not intended to limit the technical solutions; under the concept of the present disclosure, technical features in the above embodiments or different embodiments may also be combined, the steps may be implemented in any order, and there are many other changes in the various aspects of the present disclosure as described above, which are not provided in details for brevity; although the present disclosure is described in detail with reference to the foregoing embodiments, those ordinarily skilled in the art should understand that they may still modify the technical solutions recorded in the foregoing embodiments, or equivalently replace some of the technical features; and these modifications or replacements do not make the essence of the corresponding technical solutions depart from the scope of the technical solutions of the various embodiments of the present disclosure.

What is claimed is:

1. A remote diagnostic method, comprising:
receiving, by a second communication device, first communication information sent by a diagnostic device, wherein the second communication device is comprised in a remote diagnostic system, and the remote diagnostic system further comprises a first communication device and the diagnostic device, wherein the second communication device is communicatively connected to the diagnostic device and a server, and the first communication device is communicatively connected to the server and a vehicle;
sending, by the second communication device, first response information to the diagnostic device based on an information type of the first communication information, wherein the first response information is configured for responding to the first communication information;
transferring, by the second communication device, the first communication information to the vehicle through the server and the first communication device, wherein the vehicle generates first reply information based on the first communication information, and the first communication device sends the first reply information to the second communication device via the server; and
receiving, by the second communication device, the first reply information, and sending, by the second communication device, the first reply information to the diagnostic device, wherein the diagnostic device performs remote diagnostics based on the first reply information.

2. The method according to claim 1, wherein in response to determining that a communication protocol of the remote diagnostic system is a unified diagnostic services (UDS) protocol or an ISO15765 protocol, sending the first response information to the diagnostic device based on the information type of the first communication information comprises:
in response to determining that the first communication information is a first frame, acquiring a plurality of target electronic control unit (ECU) identifiers corresponding to a diagnostic device identifier from a configuration file of the vehicle; and
sending a plurality of supplementary flow control frames to the diagnostic device, wherein a frame identifier (ID) of at least one of the plurality of supplementary flow control frames is in one-to-one correspondence with at least one of the plurality of target ECU identifiers.

3. The method according to claim 2, wherein after acquiring the plurality of target electronic control unit (ECU) identifiers corresponding to the diagnostic device identifier from the configuration file of the vehicle, and before sending the plurality of supplementary flow control frames to the diagnostic device, the method further comprises:
acquiring a first time interval between the first frame and the plurality of supplementary flow control frames from the configuration file; and
sending the plurality of supplementary flow control frames to the diagnostic device after the first time interval elapses.

4. The method according to claim 2, wherein after sending the plurality of supplementary flow control frames to the diagnostic device, the method further comprises:
acquiring a second time interval from the configuration file; and
sending the second time interval to the diagnostic device, wherein the diagnostic device sends a data frame after the second time interval elapses after receiving the plurality of supplementary flow control frames.

5. The method according to claim 2, wherein
a data sending pacing value in a supplementary flow control frame sent firstly is set to be a preset empirical value, and data sending pacing values in subsequently sent supplementary flow control frames are set to be real-time data sending pacing values in flow control frames returned by the vehicle based on the first frame.

6. The method according to claim 2, further comprising:
acquiring a parameter value in the configuration file; and
setting a data sending pacing value in a supplementary flow control frame sent firstly to be the parameter value, and setting data sending pacing values in subsequently sent supplementary flow control frames to be real-time data sending pacing values in flow control frames returned by the vehicle based on the first frame.

7. The method according to claim 1, wherein in response to determining that a communication protocol of the remote diagnostic system is a TP20/TP16 protocol, sending the first response information to the diagnostic device based on the information type of the first communication information comprises:
in response to determining that the information type of the first communication information is a connection test frame, sending a connection acknowledgment frame to the diagnostic device.

8. The method according to claim 1, wherein in response to determining that a communication protocol of the remote diagnostic system is a TP20/TP16 protocol, sending the first response information to the diagnostic device based on the information type of the first communication information comprises:
in response to determining that the information type of the first communication information is a first data frame, sending a first acknowledgment frame to the diagnostic device.

9. The method according to claim 8, wherein transferring the first communication information to the vehicle through the server and the first communication device, wherein the vehicle generates the first reply information based on the first communication information comprises:
transferring the first data frame to the vehicle through the server and the first communication device, wherein the vehicle generates a first reply data frame and a second acknowledgment frame based on the first data frame; and
receiving the first reply information comprises:
receiving the first reply data frame, wherein the second acknowledgment frame is filtered out by the first communication device.

10. A remote diagnostic method, performed by a first communication device, comprising:
receiving first communication information sent by a vehicle, wherein the first communication device is comprised in a remote diagnostic system, and the remote diagnostic system further comprises a second communication device and a diagnostic device, wherein the second communication device is communicatively connected to the diagnostic device and a server respectively, and the first communication device is communicatively connected to the server and the vehicle respectively;
sending first response information to the vehicle based on an information type of the first communication information, wherein the first response information is configured for responding to the first communication information;
transferring the first communication information to the diagnostic device through the server and the second communication device, wherein the diagnostic device generates first diagnostic information based on the first communication information, and the second communication device sends the first diagnostic information to the first communication device via the server; and
receiving the first diagnostic information, and sending the first diagnostic information to the vehicle.

11. The method according to claim 10, further comprising:
in response to detecting that the diagnostic device does not send a request frame to the vehicle beyond a first preset duration, sending a link keep-alive frame to the vehicle, wherein the vehicle keeps a communication link.

12. A first communication device, comprising:
one or more processors; and
a memory communicatively connected to the one or more processors; wherein
the first communication device is comprised in a remote diagnostic system, the remote diagnostic system further comprises a second communication device and a diagnostic device, wherein the second communication device is communicatively connected to the diagnostic device and a server, and the first communication device is communicatively connected to the server and a vehicle; and
the memory stores instructions executable by the one or more processors, and the instructions are executed by the one or more processors to enable the one or more processors to perform operations comprising:
receiving first communication information sent by a vehicle, wherein the first communication device is comprised in a remote diagnostic system, and the remote diagnostic system further comprises a second communication device and a diagnostic device, wherein the second communication device is communicatively connected to the diagnostic device and a server respectively, and the first communication device is communicatively connected to the server and the vehicle respectively;
sending first response information to the vehicle based on an information type of the first communication information, wherein the first response information is configured for responding to the first communication information;
transferring the first communication information to the diagnostic device through the server and the second communication device, wherein the diagnostic device generates first diagnostic information based on the first communication information, and the second communication device sends the first diagnostic information to the first communication device via the server; and
receiving the first diagnostic information, and sending the first diagnostic information to the vehicle.

13. The first communication device according to claim 12, wherein in response to determining that a communication protocol of the remote diagnostic system is a unified diagnostic services (UDS) protocol or an ISO15765 protocol, sending the first response information to the diagnostic device based on the information type of the first communication information comprises:
in response to determining that the first communication information is a first frame, acquiring a plurality of target electronic control unit (ECU) identifiers corresponding to a diagnostic device identifier from a configuration file of the vehicle; and
sending a plurality of supplementary flow control frames to the diagnostic device, wherein a frame identifier (ID) of at least one of the plurality of supplementary flow control frames is in one-to-one correspondence with at least one of the plurality of target ECU identifiers.

14. The first communication device according to claim 13, wherein after acquiring the plurality of target electronic control unit (ECU) identifiers corresponding to the diagnostic device identifier from the configuration file of the vehicle, and before sending the plurality of supplementary flow control frames to the diagnostic device, the one or more processors are configured to perform operations comprising:
acquiring a first time interval between the first frame and the plurality of supplementary flow control frames from the configuration file; and
sending the plurality of supplementary flow control frames to the diagnostic device after the first time interval elapses.

15. The first communication device according to claim 13, wherein after sending the plurality of supplementary flow control frames to the diagnostic device, the method further comprises:
acquiring a second time interval from the configuration file; and
sending the second time interval to the diagnostic device, wherein the diagnostic device sends a data frame after the second time interval elapses after receiving the plurality of supplementary flow control frames.

16. The first communication device according to claim 13, wherein a data sending pacing value in a supplementary flow control frame sent firstly is set to be a preset empirical value, and data sending pacing values in subsequently sent supplementary flow control frames are set to be real-time data sending pacing values in flow control frames returned by the vehicle based on the first frame.

17. The first communication device according to claim 13, wherein the instructions are executed by the one or more processors to enable the one or more processors to perform operation further comprising:
acquiring a parameter value in the configuration file; and
setting a data sending pacing value in a supplementary flow control frame sent firstly to be the parameter value, and setting data sending pacing values in subsequently sent supplementary flow control frames to be real-time data sending pacing values in flow control frames returned by the vehicle based on the first frame.

18. The first communication device according to claim 12, wherein in response to determining that a communication protocol of the remote diagnostic system is a TP20/TP16 protocol, sending the first response information to the diagnostic device based on the information type of the first communication information comprises:
in response to determining that the information type of the first communication information is a connection test frame, sending a connection acknowledgment frame to the diagnostic device.

19. The first communication device according to claim 12, wherein in response to determining that a communication protocol of the remote diagnostic system is a TP20/TP16 protocol, sending the first response information to the diagnostic device based on the information type of the first communication information comprises:
in response to determining that the information type of the first communication information is a first data frame, sending a first acknowledgment frame to the diagnostic device.

20. A second communication device, comprising:
one or more processors; and
a memory communicatively connected to the one or more processors; wherein
the second communication device is comprised in a remote diagnostic system, wherein the remote diagnostic system further comprises a first communication device and a diagnostic device, wherein the second communication device is communicatively connected to the diagnostic device and a server, and the first communication device is communicatively connected to the server and a vehicle; and
the memory stores instructions executable by the one or more processors, and the instructions are executed by the one or more processors to enable the one or more processors to perform the remote diagnostic method according to claim 1.
